(19) United States
(12) Patent Application Publication
(10) Pub. No.: US 2026/0034972 A1
(43) Pub. Date: Feb. 5, 2026

(54) BRAKE APPARATUS

(71) Applicant: HL MANDO CORPORATION, Gyeonggi-do (KR)

(72) Inventor: Yongkyun JUNG, Gyeonggi-do (KR)

(21) Appl. No.: 19/040,854

(22) Filed: Jan. 29, 2025

(30) Foreign Application Priority Data
Jul. 30, 2024 (KR) 10-2024-0101129

(51) Int. Cl. B60T 8/96; B60T 8/171; B60T 8/172; B60T 8/32; B60T 8/88

(52) U.S. Cl. CPC B60T 8/96; B60T 8/171; B60T 8/172; B60T 8/321; B60T 8/885; B60T 2240/00; B60T 2270/402; B60T 2270/413

(57) ABSTRACT

A brake apparatus may include first and second wheel speed sensors disposed in each of wheels of a vehicle and configured to measure a speed of the wheel, a controller configured to control braking of the wheel in response to a wheel speed signal outputted from at least one of the first and second wheel speed sensors, a brake actuator disposed in each of the wheels of the vehicle and configured to brake the wheel, first and second brake drive circuits configured to control a driving power source of the brake actuator on the basis of the control of the controller, an actuator housing to which the first and second wheel speed sensors are coupled and in which the first and second brake drive circuits are accommodated, and a plurality of circuits configured to connect each of the first wheel speed sensor, the second wheel speed sensor, the first brake drive circuit, and the second brake drive circuit to the controller.

### CROSS-REFERENCE TO RELATED APPLICATIONS

This application claims the priority of Korean Patent Application No. 10-2024-0101129 filed on Jul. 30, 2024, in the Korean Intellectual Property Office, the disclosure of which is incorporated herein by reference.

### BACKGROUND

### Field

The disclosed disclosure relates to a brake apparatus.

### Description of the Related Art

Electromechanical brakes (EMBs) have been developed and widely used. The electromechanical brake has been developed as an electronic parking brake (EPB). However, recently, the use of the electromechanical brake is expanded as a main brake that substitutes for a hydraulic brake in the related art. The EMB refers to a device in which an actuator configured to be operated by a motor is mounted on a brake caliper, such that the EMB directly brakes a vehicle by using driving power of the motor without using a medium called a brake fluid. The EMB has a mechanism similar to that of the electric parking brake (EPB). However, because the EMB is mainly used to mainly brake the vehicle, unlike the EPB, the EMB requires higher braking responsiveness and operational durability than the EPB. In addition, in comparison with a hydraulic brake, the electromechanical brake may have a simple structure and a high response speed and be controlled more precisely, thereby improving braking safety.

In case that a measurement means for measuring a speed or a control means for controlling an operation of an actuator is abnormal, the electromechanical brake may have a problem with vehicle braking stability. Therefore, there is a need for various design solutions for the electromechanical brake to solve the problem with braking stability.

### SUMMARY

An object to be achieved by the present disclosure is to provide a brake apparatus robust against damage to or errors of components of a vehicle.

Another object to be achieved by the present disclosure is to provide a brake apparatus capable of providing redundancy to an electrical device.

Still another object to be achieved by the present disclosure is to provide a brake apparatus in which an electrical device is integrated with a brake actuator.

A brake apparatus according to one aspect of the disclosed disclosure may include: first and second wheel speed sensors disposed in each of wheels of a vehicle and configured to measure a speed of the wheel; a controller configured to control braking of the wheel in response to a wheel speed signal outputted from at least one of the first and second wheel speed sensors; a brake actuator disposed in each of the wheels of the vehicle and configured to brake the wheel; first and second brake drive circuits configured to control a driving power source of the brake actuator on the basis of the control of the controller; an actuator housing to which the first and second wheel speed sensors are coupled and in which the first and second brake drive circuits are accommodated; and a plurality of circuits configured to connect each of the first wheel speed sensor, the second wheel speed sensor, the first brake drive circuit, and the second brake drive circuit to the controller.

The controller may include a processor configured to receive the wheel speed signal of at least one of the first wheel speed sensor and the second wheel speed sensor.

The plurality of circuits may include first and second circuits provided to be separated from each other and configured to connect the processor to the first wheel speed sensor, the second wheel speed sensor, the first brake drive circuit, and the second brake drive circuit.

The processor may transmit a braking signal, which is based on the wheel speed signal of at least one of the first and second wheel speed sensors, to at least one of the first and second brake drive circuits through any one of the first and second circuits and provide power to at least one of the first and second brake drive circuits through the other of the first and second circuits.

The processor may transmit a braking signal to the other of the first and second brake drive circuits through the first circuit and provide power to the other of the first and second brake drive circuits through the second circuit in an abnormal state of any one of the first and second brake drive circuits.

The controller may include first and second processors configured to receive the wheel speed signal of at least one of the first and second wheel speed sensors.

The plurality of circuits may include first and second circuits separated from each other and configured to connect each of the first and second processors to the first wheel speed sensor, the second wheel speed sensor, the first brake drive circuit, and the second brake drive circuit.

The processor may transmit a braking signal to the other of the first and second brake drive circuits through the first circuit and provide power to the other of the first and second brake drive circuits through the second circuit in an abnormal state of any one of the first and second brake drive circuits.

The controller may include first and second processors configured to receive the wheel speed signal of at least one of the first and second wheel speed sensors.

The plurality of circuits may include first and second circuits separated from each other and configured to connect each of the first and second processors to the first wheel speed sensor, the second wheel speed sensor, the first brake drive circuit, and the second brake drive circuit.

At least one of the first and second processors may transmit a braking signal, which is based on the wheel speed signal of at least one of the first and second wheel speed sensors, to at least one of the first and second brake drive circuits through any one of the first and second circuits and provide power to at least one of the first and second brake drive circuits through the other of the first and second circuits.

At least one of the first and second processors may transmit a braking signal to the other of the first and second brake drive circuits through the first circuit and provide power to the other of the first and second brake drive circuits through the second circuit in an abnormal state of any one of the first and second brake drive circuits.

A brake apparatus according to another aspect of the disclosed disclosure may include: first and second wheel speed sensors disposed in each of wheels of a vehicle and configured to measure a speed of the wheel; a first controller configured to control braking of the wheel in response to a wheel speed signal outputted from any one of the first and second wheel speed sensors; a second controller configured to receive a wheel speed signal outputted from the other of the first and second wheel speed sensors and communicate with the first controller through an internal network of the vehicle; a brake actuator disposed in each of the wheels of the vehicle and configured to brake the wheel; first and second brake drive circuits configured to control a driving power source of the brake actuator on the basis of the control of the first controller; an actuator housing to which the first and second wheel speed sensors are coupled and in which the first and second brake drive circuits are accommodated; and a plurality of circuits configured to connect each of the first wheel speed sensor, the second wheel speed sensor, the first brake drive circuit, and the second brake drive circuit to the controller.

The first controller may include a first processor configured to receive the wheel speed signal of any one of the first and second wheel speed sensors, and the second controller may include a second processor configured to receive the wheel speed signal of the other of the first and second wheel speed sensors.

The plurality of circuits may include first and second circuits provided to be separated from each other and configured to connect the first processor to any one of the first and second wheel speed sensors, the first brake drive circuit, and the second brake drive circuit.

The first processor may transmit a braking signal, which is based on the wheel speed signal of any one of the first and second wheel speed sensors, to at least one of the first and second brake drive circuits through any one of the first and second circuits and provide power to at least one of the first and second brake drive circuits through the other of the first and second circuits.

The first processor may transmit a braking signal to the other of the first and second brake drive circuits through the first circuit and provide power to the other of the first and second brake drive circuits through the second circuit in an abnormal state of any one of the first and second brake drive circuits.

The plurality of circuits may include third and fourth circuits provided to be separated from each other and configured to connect the second processor to the other of the first and second wheel speed sensors.

The second processor may receive the wheel speed signal of the other of the first and second wheel speed sensors through any one of the third and fourth circuits, transmit the wheel speed signal to the first processor through the internal network of the vehicle, and provide power to the other of the first and second wheel speed sensors through the other of the third and fourth circuits.

The plurality of circuits may be provided to be separated from one another and include: first and second circuits configured to connect the first processor to any one of the first and second wheel speed sensors, the first brake drive circuit, and the second brake drive circuit; and third and fourth circuits configured to connect the second processor to the other of the first and second wheel speed sensors, the first brake drive circuit, and the second brake drive circuit.

The first processor may transmit a braking signal, which is based on the wheel speed signal of any one of the first and second wheel speed sensors, to at least one of the first and second brake drive circuits through any one of the first and second circuits, and the second processor may receive the wheel speed signal of the other of the first and second wheel speed sensors through any one of the third and fourth circuits, transmit the wheel speed signal to the first processor through the internal network of the vehicle, and provide power to at least one of the first and second brake drive circuits through any one of the third and fourth circuits.

The first processor may transmit the braking signal to the other of the first and second brake drive circuits through any one of the first and second circuits in an abnormal state of any one of the first and second brake drive circuits.

The second processor may provide power to the other of the first and second brake drive circuits through any one of the third and fourth circuits in an abnormal state of any one of the first and second brake drive circuits.

According to one aspect of the disclosed disclosure, it is possible to provide the brake apparatus robust against damage to or errors of the components of the vehicle.

According to one aspect of the disclosed disclosure, it is possible to provide the brake apparatus capable of providing redundancy to the electrical device.

According to one aspect of the disclosed disclosure, it is possible to provide the brake apparatus in which the electrical device is integrated with the brake actuator.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a configuration of a vehicle according to an embodiment of the present disclosure;

FIG. 2 is a view exemplarily illustrating a partial structure of a brake apparatus included in a vehicle according to a first embodiment of the present disclosure;

FIG. 3 is a view illustrating a connection relationship between components included in the brake apparatus according to the first embodiment of the present disclosure;

FIG. 4 is a view illustrating a connection relationship between components included in a brake apparatus according to a second embodiment of the present disclosure;

FIG. 5 is a view illustrating a configuration of the brake apparatus included in a vehicle according to the second embodiment of the present disclosure;

FIG. 6 is a view illustrating a connection relationship between components included in a brake apparatus according to a third embodiment of the present disclosure;

FIG. 7 is a view illustrating a configuration of the brake apparatus included in a vehicle according to the third embodiment of the present disclosure; and

FIG. 8 is a view illustrating a connection relationship between components included in a brake apparatus according to a fourth embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the present when one specification, constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

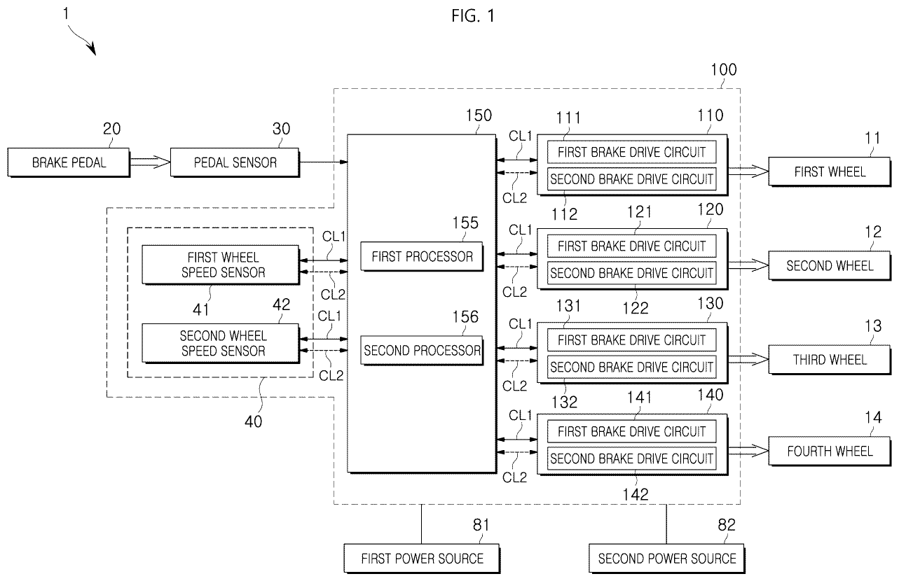

FIG. 1 is a view illustrating a configuration of a brake apparatus included in a vehicle according to a first embodiment of the present disclosure.

With reference to FIG. 1, a vehicle 1 includes a vehicle body configured to define an external appearance of the vehicle and accommodate a driver and/or baggage, a chassis including constituent components of the vehicle 1 except for the vehicle body, and wheels 11, 12, 13, and 14 configured to rotate to move the vehicle 1.

For example, the wheels 11, 12, 13, and 14 may include a first wheel 11 provided at a front left side of the vehicle 1, a second wheel 12 provided at a front right side of the vehicle 1, a third wheel 13 provided at a rear left side of the vehicle 1, and/or a fourth wheel 14 provided at a rear right side of the vehicle 1. The number of wheels 11, 12, 13, and 14 is not limited to four.

In addition, as illustrated in FIG. 1, the vehicle 1 may include a brake pedal 20 configured to acquire an input related to braking from a driver, a pedal sensor 30 configured to detect a movement of the brake pedal 20, wheel speed sensors 40 configured to detect rotational speeds of the wheels 11, 12, 13, and 14, a steering wheel 60 configured to acquire an input related to steering from the driver, a steering sensor 70 configured to detect a rotation of the steering wheel 60, a brake apparatus 100 configured to provide the wheels 11, 12, 13, and 14 with a braking force for stopping the vehicle 1, and first and second power sources 81 and 82 configured to supply power to the brake apparatus 100 and the like.

For example, the brake pedal 20 may be provided at a lower side of a cabin so that the driver may control the brake pedal 20 with his/her foot. The driver may push the brake pedal 20 in accordance with a braking intention to brake the vehicle 1. In accordance with the driver's braking intention, the brake pedal 20 may depart from a reference position and move.

The pedal sensor 30 may be installed in the vicinity of the brake pedal 20 and measure the movement of the brake pedal 20 made by the driver's braking intention. For example, the pedal sensor 30 may detect a movement distance and/or a movement speed of the brake pedal 20 from a reference position.

The pedal sensor 30 may be electrically connected to the brake apparatus 100 and provide an electrical signal to the brake apparatus 100. For example, the pedal sensor 30 may be connected directly to the brake apparatus 100 through a hard wire or connected to the brake apparatus 100 through a communication network. In addition, the pedal sensor 30 may provide the brake apparatus 100 with an electrical signal corresponding to the movement distance and/or the movement speed of the brake pedal 20.

The wheel speed sensors 40 may include a plurality of wheel speed sensors respectively installed in the wheels 11, 12, 13, and 14. For example, the plurality of wheel speed sensors may include a first wheel speed sensor 41 and a second wheel speed sensor 42. The first wheel speed sensor 41 and the second wheel speed sensor 42 may independently detect the rotational speeds of the wheels 11, 12, 13, and 14.

The plurality of wheel speed sensors 41 and 42 may be electrically connected to the brake apparatus 100 and provide electrical signals to the brake apparatus 100. For example, the first wheel speed sensor 41 and the second wheel speed sensor 42 may be connected to the brake apparatus 100 through a communication network and provide the brake apparatus 100 with the electrical signals corresponding to the rotational speeds of the wheels 11, 12, 13, and 14.

The brake apparatus 100 may include electromechanical brake actuators 110, 120, 130, and 140 respectively installed in the wheels 11, 12, 13, and 14, and a controller 150 configured to control the brake actuators 110, 120, 130, and 140.

The brake actuators 110, 120, 130, and 140 may brake the wheels 11, 12, 13, and 14 and brake the vehicle 1. For example, the brake actuators 110, 120, 130, and 140 may include a first brake actuator 110 configured to brake the first wheel 11, a second brake actuator 120 configured to brake the second wheel 12, a third brake actuator 130 configured to brake the third wheel 13, and/or a fourth brake actuator 140 configured to brake the fourth wheel 14. However, the number of brake actuators 110, 120, 130, and 140 is not limited to four.

The brake actuators 110, 120, 130, and 140 may be operated by a braking signal outputted from the controller 150 without being mechanically or fluidly connected to the brake pedal 20.

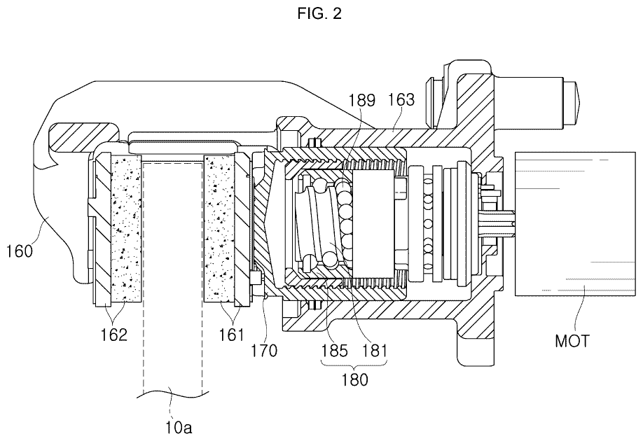

For example, as illustrated in FIG. 2, the brake actuators 110, 120, 130, and 140 may each include a caliper brake.

The brake actuators 110, 120, 130, and 140 may each include a pair of pad plates 161 and 162 installed to press a brake disc 10a configured to rotate together with each of the wheels 11, 12, 13, and 14, a caliper housing 160 configured to operate the pair of pad plates 161 and 162 (including brake pads), a piston 170 installed in the caliper housing 160 and configured to advance or retract, a power conversion unit 180 configured to receive rotational driving power for moving the piston 170, convert the rotational driving power into linear driving power, and transmit linear driving power to the piston 170, and a brake motor MOT configured to operate as a driving source to generate rotational driving power for moving the piston 170.

The piston 170 may be provided in a cup shape opened at the rear side (right side in FIG. 2) and sliding movably inserted into a cylinder part 163. In addition, the piston 170 may press an inner pad plate 161 toward the brake disc 10a by receiving power through the power conversion unit 180.

The power conversion unit 180 may include a spindle 181 configured to rotate by receiving driving power from the brake motor MOT, a nut 185 disposed in the piston 170, screw-connected to the spindle 181, and configured to be advanced together with the piston 170 by a rotation of the spindle 181 in a first direction or retracted together with the piston 170 by a rotation of the spindle 181 in a second direction, and a plurality of balls 189 interposed between the spindle 181 and the nut 185. The power conversion unit 180 may be provided as a ball-screw type conversion device configured to convert a rotational motion of the spindle 181 into a linear motion.

A rotational motion of the brake motor MOT may be converted into a linear motion of the piston 170 by the power conversion unit 180. The pair of pad plates 161 and 162 may be compressed toward the brake disc 10a by the linear motion of the piston 170, and the wheels 11, 12, 13, and 14 may be braked by friction between the pair of pad plates 161 and 162 and the brake disc 10a.

FIG. 2 illustrates the caliper brake as an example of the brake actuator. However, the present disclosure is not limited thereto. For example, the brake actuator may include a drum brake.

The brake actuators 110, 120, 130, and 140 may accommodate therein brake drive circuits 111, 112, 121, 122, 131, 132, 141, and 142 configured to control a driving power source of the brake motor MOT. In addition, the brake actuators 110, 120, 130, and 140 may brake the wheels 11, 12, 13, and 14 in accordance with the operation of the brake motor MOT without being mechanically or fluidly connected to the brake pedal 20. Therefore, it is possible to eliminate a mechanism or hydraulic circuit extending from the brake pedal 20 to each of the brake actuators 110, 120, 130, and 140.

The controller 150 may receive output signals of the pedal sensor 30, the wheel speed sensor 40, a motion sensor 50, and/or a steering sensor 70 and control the operations of the brake actuators 110, 120, 130, and 140.

The controller 150 may provide braking signals to the brake actuators 110, 120, 130, and 140 to brake the vehicle 1 in response to the electrical signal outputted from the pedal sensor 30. For example, the controller 150 may identify a braking force (or braking acceleration) for braking the vehicle 1 in response to the output signal of the pedal sensor 30 and provide the brake actuators 110, 120, 130, and 140 with the braking signal corresponding to the identified braking force (or braking acceleration).

The controller 150 may distribute the braking force to the brake actuators 110, 120, 130, and 140 to brake the vehicle 1 in response to the electrical signal outputted from the pedal sensor 30. For example, the controller 150 may distribute the driver's required braking force to the brake actuators 110, 120, 130, and 140 and provide the brake actuators 110, 120, 130, and 140 with the braking signal corresponding to the distributed braking force. As described above, the brake apparatus 100 may include an electronic brake force distribution (EBD).

The controller 150 may provide the braking signals to the brake actuators 110, 120, 130, and 140 to temporarily allow the rotations of the wheels 11, 12, 13, and 14 in response to the electrical signal outputted from the wheel speed sensor 40. For example, the controller 150 may identify slips of the wheels 11, 12, 13, and 14 in response to the output signal of the wheel speed sensor 40 while the vehicle 1 is braked. The controller 150 may provide the brake actuators 110, 120, 130, and 140 with the braking signals for temporarily allowing the rotations of the wheels 11, 12, 13, and 14 to eliminate the slips of the wheels 11, 12, 13, and 14 in response to the slips of the wheels 11, 12, 13, and 14. As described above, the brake apparatus 100 may include an anti-lock braking system (ABS).

The controller 150 may provide the braking signals to the brake actuators 110, 120, 130, and 140 to temporarily brake the wheels 11, 12, 13, and 14 without the user's braking intention in response to the electrical signal outputted from the wheel speed sensor 40. For example, the controller 150 may identify spins of the wheels 11, 12, 13, and 14 in response to the output signal of the wheel speed sensor 40 while the vehicle 1 travels. The controller 150 may provide the brake actuators 110, 120, 130, and 140 with the braking signals for temporarily braking the wheels 11, 12, 13, and 14 to eliminate the spins of the wheels 11, 12, 13, and 14 in response to the spins of the wheels 11, 12, 13, and 14. As described above, the brake apparatus 100 may include a traction control system (TCS).

The controller 150 may provide parking signals to the brake actuators 110, 120, 130, and 140 in order to prevent the rotations of the wheels 11, 12, 13, and 14 in response to the driver's parking instruction. As described above, the brake apparatus 100 may include an electronic parking brake (EPB).

The controller 150 may include a plurality of processors 151 and 152 to prepare for damage to and errors of an electric system and perform preset functions. For example, the controller 150 may include a first processor 155 and a second processor 156.

The first processor 155 may process the output signal of the pedal sensor 30 and/or the wheel speed sensor 40, identify the braking force (or braking acceleration or engagement force) corresponding to the service brake, the EBD, the ABS, the TSC, the ESC, the EPB, and the like on the basis of the result of processing the output signal, and output the braking signals, which correspond to the braking forces, to the brake actuators 110, 120, 130, and 140. The brake actuators 110, 120, 130, and 140 may brake the wheels 11, 12, 13, and 14 with the braking forces corresponding to the braking signals.

The first processor 155 may communicate with the second processor 156. For example, the first processor 155 may periodically transmit a status signal to the second processor 156. The second processor 156 may identify a normal operating state of the first processor 155 on the basis of a result of receiving the periodic status signal by the first processor 155.

In case that the first processor 155 does not operate normally, the first processor 155 may not transmit the periodic status signal to the second processor 156. The second processor 156 may identify an abnormal operating state (e.g., damage, error, reset, power cut off, or the like) of the first processor 155 at a predetermined cycle on the basis of a situation in which the first processor 155 does not receive the periodic status signal.

The second processor 156 may also process the output signals of the pedal sensor 30, the wheel speed sensor 40, the motion sensor 50, and/or the steering sensor 70 and identify the braking forces corresponding to the service brake, the EBD, the ABS, the TSC, the ESC, the EPB, and the like on the basis of the result of processing the output signal. However, while the first processor 155 operates normally, the second processor 156 may not output the braking signals to the brake actuators 110, 120, 130, and 140, the brake actuators 110, 120, 130, and 140 may not receive the braking signal of the second processor 156, or the brake actuators 110, 120, 130, and 140 may ignore the braking signal of the second processor 156.

The second processor 156 may output the electrical signals, which correspond to the service brake, the EBD, the ABS, the TSC, the ESC, the EPB, and the like, to the brake actuators 110, 120, 130, and 140 on the basis of the result of identifying the abnormal operating state (e.g., damage, error, reset, power cut off, or the like) of the first processor 155.

As described above, because the controller 150 includes the first processor 155 and preliminary includes the second processor 156, the second processor 156 may control the brake actuators 110, 120, 130, and 140 even though the first processor 155 is damaged, the first processor 155 is reset, the supply of power to the first processor 155 is cut off.

The second processor 156 may be implemented by semiconductor elements provided separately from the first processor 155. Alternatively, the second processor 156 may be implemented by processing cores provided in a region separated from the first processor 155 in one semiconductor element.

The second processor 156 may have the same computation ability as the first processor 155 or have a lower computation ability than the first processor 155. For example, the number of instructions processed by the second processor 156 per unit time may be equal to or smaller than the number of instructions processed by the first processor 155 per unit time.

The first power source 81 may include a power network capable of supplying power to the pedal sensor 30, the wheel speed sensor 40, and the brake apparatus 100.

The second power source 82 may include a power network provided separately from the first power source 81 and supply power to the pedal sensor 30, the wheel speed sensor 40, and the brake apparatus 100.

The first power source 81 and the second power source 82 may include separate power circuits configured to provide power from different batteries or include separate power circuits separated from a single battery. For example, the first power source 81 may include a first power circuit configured to provide power from a first battery, and the second power source 82 may include a second power circuit configured to provide power from a second battery. Alternatively, the first power source 81 and the second power source 82 may respectively include a first power circuit and a second power circuit configured to provide power from a single battery.

As described above, the brake apparatus 100 according to the embodiment includes the first processor 155 and preliminary includes the second processor 156, such that the second processor 156 may be used to brake the vehicle 1 even though the first processor 155 is damaged or the supply of power to the first processor 155 is cut off.

In the following description, an electrical connection relationship between the first processor 155, the second processor 156, and the brake actuators 110, 120, 130, and 140 of the brake apparatus 100 will be described in detail.

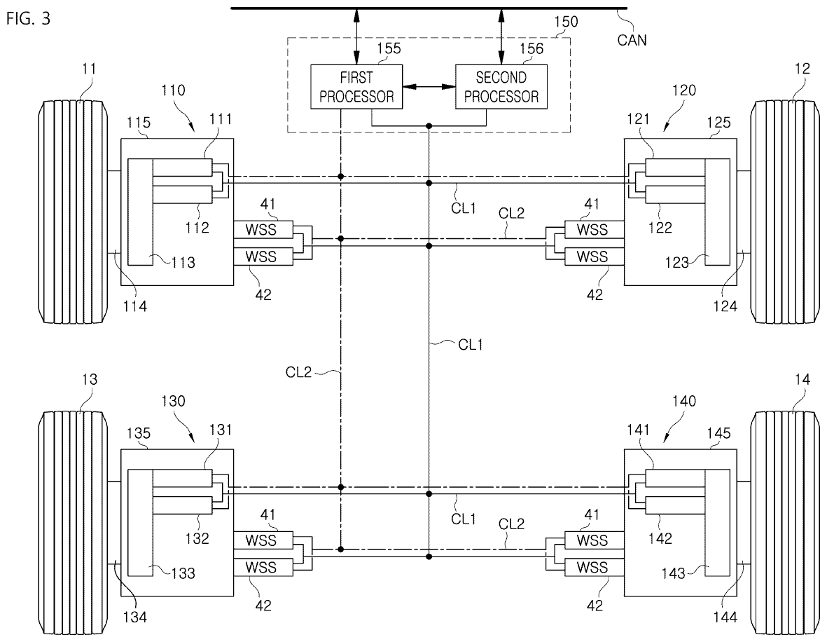

FIG. 3 is a view illustrating a connection relationship between components included in the brake apparatus according to the embodiment of the present disclosure.

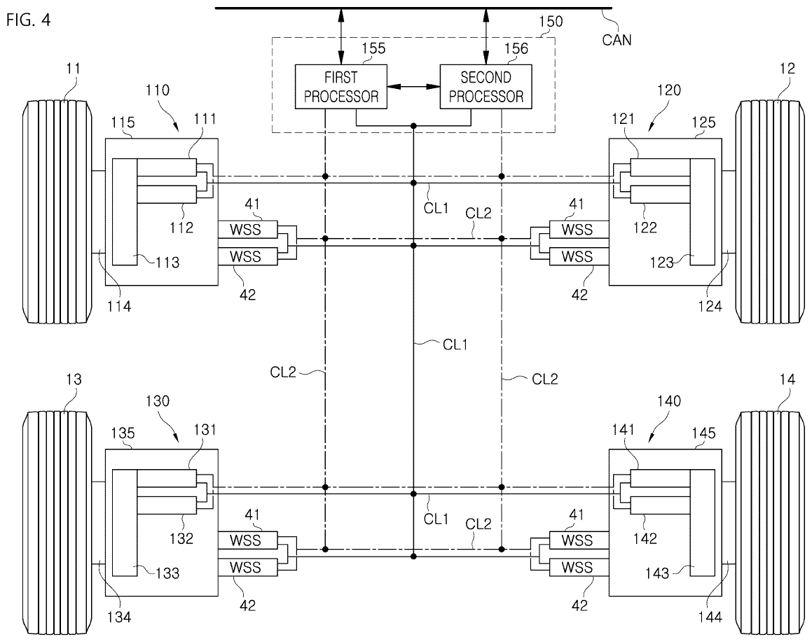

FIG. 4 is a view illustrating a connection relationship between components included in a brake apparatus according to another embodiment of the present disclosure.

As illustrated in FIG. 3, the brake apparatus 100 may include the brake actuators 110, 120, 130, and 140 disposed in the wheels 11, 12, 13, and 14, the first processor 155, and the second processor 156.

The brake actuators 110, 120, 130, and 140 may include actuator housings 115, 125, 136, and 145 to which the first wheel speed sensor 41 and the second wheel speed sensor 42 are coupled and in which first brake drive circuits 111, 121, 131, and 141 and second brake drive circuits 112, 122, 132, and 142 are accommodated.

The first wheel speed sensor 41 and the second wheel speed sensor 42 may be coupled to external ports of the actuator housings 115, 125, 136, and 145 or separate ports. The first wheel speed sensor 41 and the second wheel speed sensor 42 may each be electrically connected to at least one of the first processor 155 and the second processor 156. The first wheel speed sensor 41 and the second wheel speed sensor 42 may each output a wheel speed signal WSS, which corresponds to rotational speeds of the wheels 11, 12, 13, and 14, to the first processor 155 and the second processor 156.

Brake motors 113, 123, 133, and 143 may provide torque for moving brake pads 114, 124, 134, and 144 so that the brake pads 114, 124, 134, and 144 come into contact with the brake discs. The rotations of the brake motors 113, 123, 133, and 143 may be converted into linear movements by means of the spindles, and the pad plates may come into contact with the brake discs by the linear movements of the pistons.

The brake pads 114, 124, 134, and 144 may brake the wheels 11, 12, 13, and 14 by coming into contact with the brake discs (not illustrated) that rotate together with the wheels 11, 12, 13, and 14.

The first brake drive circuits 111, 121, 131, and 141 and the second brake drive circuits 112, 122, 132, and 142 may be accommodated in the actuator housings 115, 125, 136, and 145.

At least one of the first brake drive circuits 111, 121, 131, and 141 and the second brake drive circuits 112, 122, 132, and 142 may control a drive current for rotating a brake actuator 121 in response to the braking signal of the first processor 155 or the second processor 156 and transmit a braking status signal, which indicates a braking force (or braking acceleration or engagement force) generated by each of the brake motors 113, 123, 133, and 143, to at least one of the first processor 155 and the second processor 156 through a first circuit CL1. For example, the first brake drive circuits 111, 121, 131, and 141 and the second brake drive circuits 112, 122, 132, and 142 may each include an H bridge inverter or a three-phase inverter depending on the types of the brake motors 113, 123, 133, and 143. In addition, the first brake drive circuits 111, 121, 131, and 141 and the second brake drive circuits 112, 122, 132, and 142 may each include a drive processor configured to control the H bridge inverter or the three-phase inverter to control the drive current of each of the brake motors 113, 123, 133, and 143 in response to the braking signal received from the first processor 155 or the second processor 156.

At least one of the first brake drive circuits 111, 121, 131, and 141 and the second brake drive circuits 112, 122, 132, and 142 may operate each of the brake motors 113, 123, 133, and 143 in response to a parking signal of the first processor 155 and transmit a parking status signal, which is generated by each of the brake motors 113, 123, 133, and 143, to at least one of the first processor 155 and the second processor 156 through the first circuit CL1.

The first brake drive circuits 111, 121, 131, and 141 and the second brake drive circuits 112, 122, 132, and 142 may each transmit the periodic status signal, which indicates an operating state (e.g., a normal operating state or an abnormal operating state), to at least one of the first processor 155 and the second processor 156 through the first circuit CL1.

The first processor 155 and the second processor 156 may be integrated. For example, the first processor 155 and the second processor 156 may be provided on a single substrate or provided in a single semiconductor element.

The first processor 155 and the second processor 156 may be connected to a communication network (CAN) for a vehicle. In addition, the first processor 155 and the second processor 156 may be connected to at least one of the first wheel speed sensor 41, the second wheel speed sensor 42, the first brake drive circuits 111, 121, 131, and 141, and the second brake drive circuits 112, 122, 132, and 142 through the first circuit CL1 and mutually transmit signals.

The first processor 155 and the second processor 156 may transmit a parking signal for parking to at least one of the first brake drive circuits 111, 121, 131, and 141 and the second brake drive circuits 112, 122, 132, and 142 through the first circuit CL1 on the basis of the driver's required braking force.

The first processor 155 and the second processor 156 may transmit and receive the periodic status signal, which indicates the operating state (e.g., the normal operating state or the abnormal operating state), to and from each other or transmit the periodic status signal to at least one of the first brake drive circuits 111, 121, 131, and 141 and the second brake drive circuits 112, 122, 132, and 142.

The first processor 155 and the second processor 156 may provide power to at least one of the first wheel speed sensor 41, the second wheel speed sensor 42, the first brake drive circuits 111, 121, 131, and 141, and the second brake drive circuits 112, 122, 132, and 142 through a second circuit CL2.

At least one of the first processor 155 and the second processor 156 may transmit the braking signal to another of the first brake drive circuits 111, 121, 131, and 141 and the second brake drive circuits 112, 122, 132, and 142 through the first circuit CL1 in an abnormal state of any one of the first brake drive circuits 111, 121, 131, and 141 and the second brake drive circuits 112, 122, 132, and 142.

At least one of the first processor 155 and the second processor 156 may transmit the braking signal, which is based on the output of the other of the first wheel speed sensor 41 and the second wheel speed sensor 42, to at least one of the first brake drive circuits 111, 121, 131, and 141 and the second brake drive circuits 112, 122, 132, and 142 through the first circuit CL1 in the abnormal state of any one of the first wheel speed sensor 41 and the second wheel speed sensor 42.

The first circuit CL1 may be an independent exclusive communication network separated from the communication network (CAN) for a vehicle. The first circuit CL1 may connect at least one of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and transmit the signal. For example, the first circuit CL1 may use various communication methods such as Ethernet, media-oriented system transport (MOST), Flexray, controller area network (CAN), and local interconnect network (LIN).

The second circuit CL2 may be a circuit separated from the first circuit CL1. The second circuit CL2 may connect at least one of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and provide power.

However, according to the embodiment, any one of the first circuit CL1 and the second circuit CL2 may connect at least one of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and transmit the signal, and the other of the first circuit CL1 and the second circuit CL2 may connect at least one of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and provide power.

According to the embodiment, as illustrated in FIG. 3, the first circuit CL1 may connect at least one of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and transmit the signal.

The second circuit CL2 may connect the first processor 155 to at least one of the first wheel speed sensor 41, the second wheel speed sensor 42, the first brake drive circuits 111, 121, 131, and 141, and the second brake drive circuits 112, 122, 132, and 142 and provide power.

According to another embodiment, as illustrated in FIG. 4, the first circuit CL1 may connect at least one of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and transmit the signal.

The second circuit CL2 may connect each of the first processor 155 and the second processor 156 to at least one of the first wheel speed sensor 41, the second wheel speed sensor 42, the first brake drive circuits 111, 121, 131, and 141, and the second brake drive circuits 112, 122, 132, and 142 and provide power.

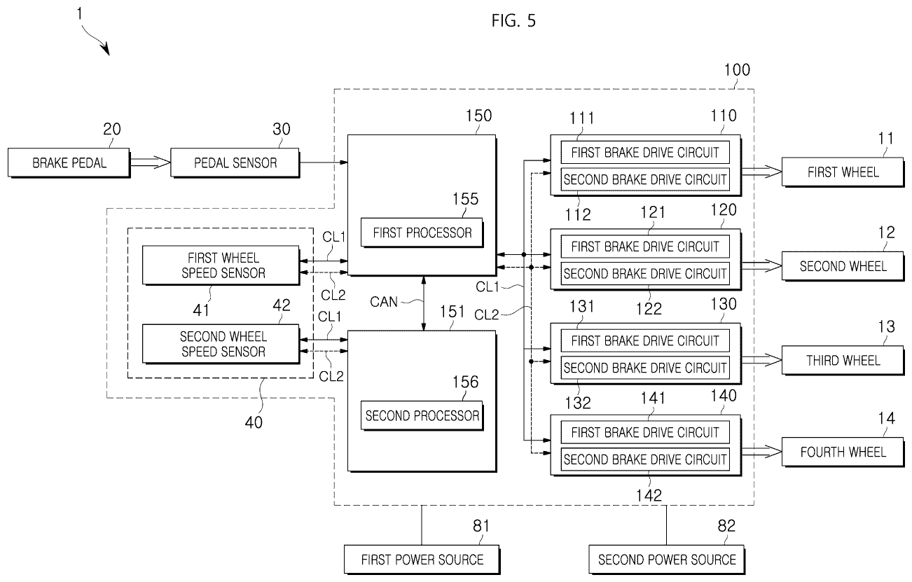

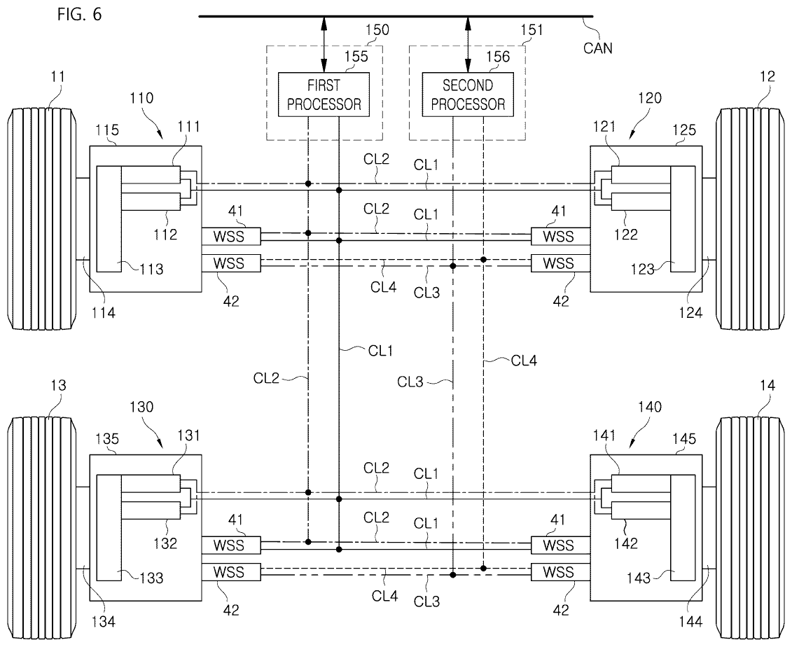

FIG. 5 is a view illustrating a configuration of the brake apparatus included in a vehicle according to the second embodiment of the present disclosure. FIG. 6 is a view illustrating a connection relationship between components included in a brake apparatus according to a third embodiment of the present disclosure.

The brake apparatus 100 according to the second embodiment differs from the brake apparatus 100 according to the first embodiment in that the brake apparatus 100 includes a first controller 150 and a second controller 151, and a plurality of circuits CL1, CL2, CL3, and CL4 includes the first circuit CL1, the second circuit CL2, a third circuit CL3, and a fourth circuit CL4.

In this case, in order to avoid the repeated description, the brake apparatus 100 will be described, focusing on the first controller 150 and the second controller 151, and the description of the components substantially identical to those of the brake apparatus 100 of the first embodiment will be omitted.

The first controller 150 may control the braking of the wheels 11, 12, 13, and 14 in response to the wheel speed signal outputted from any one of the first wheel speed sensor 41 and the second wheel speed sensor 42. The first controller 150 may include the first processor 155 configured to receive the wheel speed signal of any one of the first wheel speed sensor 41 and the second wheel speed sensor 42.

The first processor 155 may process the output signal of any one of the pedal sensor 30, the first wheel speed sensor 41, and the second wheel speed sensor 42. For example, the first processor 155 may process the output signal of the first wheel speed sensor 41.

In addition, the first processor 155 may transmit the braking signal, which is based on the wheel speed signal of any one of the first wheel speed sensor 41 and the second wheel speed sensor 42, to at least one of the first brake drive circuits 111, 121, 131, and 141 and the second brake drive circuits 112, 122, 132, and 142 through any one of the first circuit CL1 and the second circuit CL2. For example, the first processor 155 may transmit the braking signals to the first brake drive circuits 111, 121, 131, and 141 and/or the second brake drive circuits 112, 122, 132, and 142 through the first circuit CL1.

In addition, in the abnormal state of any one of the first brake drive circuits 111, 121, 131, and 141 and the second brake drive circuits 112, 122, 132, and 142, the first processor 155 may transmit the braking signal to another of the first brake drive circuits 111, 121, 131, and 141 and the second brake drive circuits 112, 122, 132, and 142 through the first circuit CL1 and provide power through the second circuit CL2.

The second controller 151 may receive the wheel speed signal outputted from the other of the first wheel speed sensor 41 and the second wheel speed sensor 42 and communicate with the first controller 150 through an internal network (CAN) of the vehicle 1. In addition, the second controller 151 may transmit the received wheel speed signal to the first controller 150.

In this case, the second controller 151 may be configured to perform a function different from that of the first controller 150. The second controller 151 may control devices other than the brake, e.g., external devices such as a steering device, an engine, and a suspension system. However, the present disclosure is not limited thereto. The second controller 151 may be configured to control various devices that are not controlled by the first controller 150.

The second controller 151 may include the second processor 156 configured to receive the wheel speed signal of the other of the first wheel speed sensor 41 and the second wheel speed sensor 42.

The second processor 156 may process the output signal of the other of the first wheel speed sensor 41 and the second wheel speed sensor 42. For example, the second processor 156 may process the output signal of the second wheel speed sensor 42.

The first processor 155 and the second processor 156 may periodically transmit and receive the electrical signals while communicating with each other. The first processor 155 may periodically transmit the status signal to the second processor 156 and identify the abnormal operating state of the first processor 155 on the basis of the situation in which the second processor 156 does not receive the periodic status signal from the first processor 155 at a predetermined cycle.

When the abnormal operating state of the first processor 155 is identified, the second processor 156 may control the brake actuators 110, 120, 130, and 140 instead of the first processor 155.

Any one of the first circuit CL1 and the second circuit CL2 may connect the first processor 155 to at least one of the first wheel speed sensor 41, the first brake drive circuits 111, 121, 131, and 141, and the second brake drive circuits 112, 122, 132, and 142 and transmit the signal.

The other of the first circuit CL1 and the second circuit CL2 may connect the first processor 155 to at least one of the first wheel speed sensor 41, the first brake drive circuits 111, 121, 131, and 141, and the second brake drive circuits 112, 122, 132, and 142 and transmit power.

For example, the first circuit CL1 may connect the first processor 155, the first wheel speed sensor 41, the first brake drive circuits 111, 121, 131, and 141, and the second brake drive circuits 112, 122, 132, and 142 and transmit the signal. The second circuit CL2 may connect the first processor 155, the first wheel speed sensor 41, the first brake drive circuits 111, 121, 131, and 141, and the second brake drive circuits 112, 122, 132, and 142 and transmit power.

Any one of the third circuit CL3 and the fourth circuit CL4 may connect the second processor 156 to the second wheel speed sensor 42 and transmit the signal, and the other of the third circuit CL3 and the fourth circuit CL4 may connect the second processor 156 to the second wheel speed sensor 42 and transmit power. For example, the third circuit CL3 may connect the second processor 156 and the second wheel speed sensor 42 and transmit the signal, and the fourth circuit CL4 may connect the second processor 156 and the second wheel speed sensor 42 and transmit power.

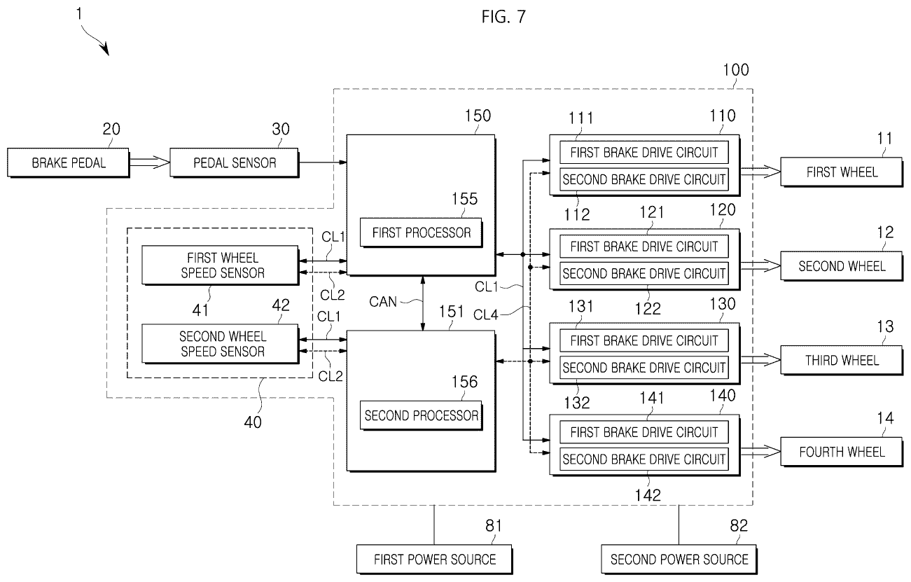

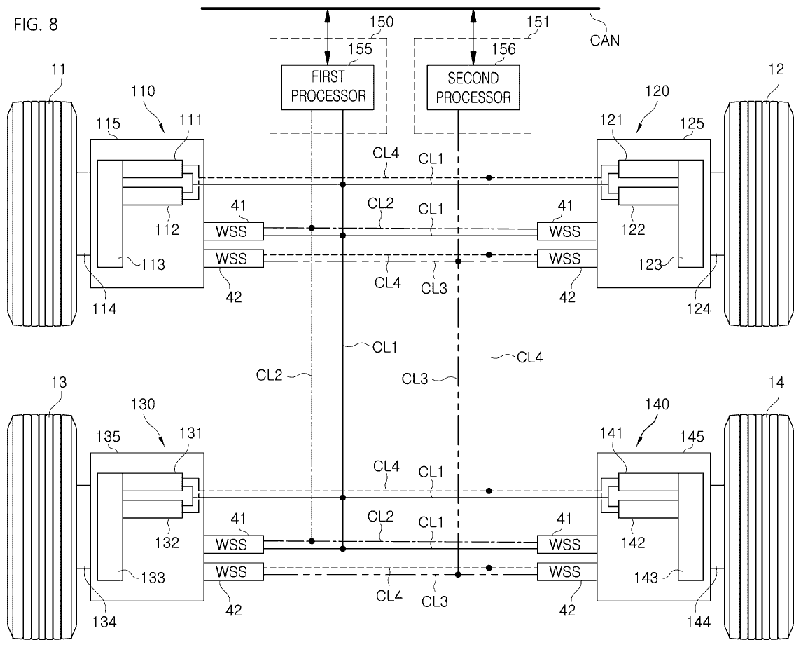

FIG. 7 is a view illustrating a configuration of the brake apparatus included in a vehicle according to the third embodiment of the present disclosure. FIG. 8 is a view illustrating a connection relationship between components included in a brake apparatus according to a fourth embodiment of the present disclosure.

The brake apparatus 100 according to the third embodiment differs from the brake apparatus 100 according to the first embodiment in that the brake apparatus 100 includes the first controller 150 and the second controller 151, and the plurality of circuits CL1, CL2, CL3, and CL4 includes the first circuit CL1, the second circuit CL2, the third circuit CL3, and the fourth circuit CL4.

In addition, the brake apparatus according to the third embodiment differs from the brake apparatus according to the second embodiment in that the first controller 150 is connected to any one of the first brake drive circuits 111, 121, 131, and 141 and the second brake drive circuits 112, 122, 132, and 142 through any one of the first circuit CL1 and the second circuit CL2, and the second controller 151 is connected to another of the first brake drive circuits 111, 121, 131, and 141 and the second brake drive circuits 112, 122, 132, and 142 through any one of the third circuit CL3 and the fourth circuit CL4.

In this case, in order to avoid the repeated description, the description of the components substantially identical to those of the brake apparatuses 100 of the first and second embodiments will be omitted.

The first processor 155 may transmit the braking signal, which is based on the wheel speed signal of the first wheel speed sensor 41, to any one of the first brake drive circuits 111, 121, 131, and 141 and the second brake drive circuits 112, 122, 132, and 142 through any one of the first circuit CL1 and the second circuit CL2. For example, the first processor 155 may transmit the braking signals to the first brake drive circuits 111, 121, 131, and 141 and/or the second brake drive circuits 112, 122, 132, and 142 through the first circuit CL1.

The second processor 156 may transmit the braking signal, which is based on the wheel speed signal of the first wheel speed sensor 41, to another of the first brake drive circuits 111, 121, 131, and 141 and the second brake drive circuits 112, 122, 132, and 142 through any one of the third circuit CL3 and the fourth circuit CL4. For example, the second processor 156 may provide power to the first brake drive circuits 111, 121, 131, and 141 and/or the second brake drive circuits 112, 122, 132, and 142 through the fourth circuit CL4.

Any one of the first circuit CL1 and the second circuit CL2 may connect the first processor 155 to at least one of the first wheel speed sensor 41, the first brake drive circuits 111, 121, 131, and 141, and the second brake drive circuits 112, 122, 132, and 142 and transmit the signal.

For example, the first circuit CL1 may connect the first processor 155, the first wheel speed sensor 41, the first brake drive circuits 111, 121, 131, and 141, and the second brake drive circuits 112, 122, 132, and 142 and transmit the signal. The fourth circuit CL4 may connect the second processor 156, the second wheel speed sensor 42, the first brake drive circuits 111, 121, 131, and 141, and the second brake drive circuits 112, 122, 132, and 142 and transmit power.

The brake apparatus according to the embodiment of the present disclosure may be robust against damage to or errors of the components of the vehicle, thereby providing braking stability.

The brake apparatus according to the embodiment of the present disclosure may provide redundancy to the electrical devices such as the circuit, the sensor, and the processor.

According to the brake apparatus according to the embodiment of the present disclosure, the electrical device is integrated with the brake actuator, such that the device is independently managed and easily maintained.

The embodiments have been described above, but the embodiments are just illustrative and not intended to limit the present specification. It can be appreciated by those skilled in the art that various modifications and alterations, which are not described above, may be made without departing from the intrinsic features of the present specification. For example, the respective constituent elements specifically described in the embodiments may be modified and then carried out. Further, it should be interpreted that the differences related to the modifications and applications are included in the scope of the present specification defined by the appended claims.

What is claimed is:

1. A brake apparatus comprising:
first and second wheel speed sensors associated with a wheel of a vehicle and configured to measure a speed of the wheel;
one or more controllers configured to control braking of the wheel of the vehicle in response to a wheel speed signal outputted from at least one of the first and second wheel speed sensors;
a brake actuator operably coupled to the wheel of the vehicle and configured to brake the wheel;
first and second brake drive circuits configured to control a power source of the brake actuator in response to control of the one or more controllers;
an actuator housing to which the first and second wheel speed sensors are coupled and in which the first and second brake drive circuits are included; and
a plurality of circuits connecting the first wheel speed sensor, the second wheel speed sensor, the first brake drive circuit, and the second brake drive circuit to the one or more controllers.

2. The brake apparatus of claim 1, wherein the one or more controllers comprises one or more processors configured to receive the wheel speed signal of at least one of the first and second wheel speed sensors.

3. The brake apparatus of claim 2, wherein the plurality of circuits comprises first and second circuits separated from each other and configured to connect the one or more processors to the first wheel speed sensor, the second wheel speed sensor, the first brake drive circuit, and the second brake drive circuit.

4. The brake apparatus of claim 3, wherein the one or more processors are configured to:
transmit a brake control signal, which is generated based on the wheel speed signal of at least one of the first and second wheel speed sensors, to at least one of the first and second brake drive circuits through one of the first and second circuits, and
supply power to at least one of the first and second brake drive circuits through another of the first and second circuits.

5. The brake apparatus of claim 3, wherein the one or more processors are configured to, in an abnormal state of one of the first and second brake drive circuits:
transmit a brake control signal to another of the first and second brake drive circuits through the first circuit, and supply power to the another of the first and second brake drive circuits through the second circuit.

6. The brake apparatus of claim 1, wherein the one or more controllers comprise first and second processors configured to receive the wheel speed signal of at least one of the first and second wheel speed sensors.

7. The brake apparatus of claim 6, wherein the plurality of circuits comprises first and second circuits separated from each other and configured to connect the first and second processors to the first wheel speed sensor, the second wheel speed sensor, the first brake drive circuit, and the second brake drive circuit.

8. The brake apparatus of claim 7, wherein at least one of the first and second processors is configured to:
transmit a brake control signal, which is generated based on the wheel speed signal of at least one of the first and second wheel speed sensors, to at least one of the first and second brake drive circuits through one of the first and second circuits, and
supply power to at least one of the first and second brake drive circuits through another of the first and second circuits.

9. The brake apparatus of claim 7, wherein at least one of the first and second processors is configured to, in an abnormal state of one of the first and second brake drive circuits:
transmit a brake control signal to another of the first and second brake drive circuits through the first circuit, and
supply power to the another of the first and second brake drive circuits through the second circuit.

10. A brake apparatus comprising:
first and second wheel speed sensors disposed in a wheel of a vehicle and configured to sense a speed of the wheel;
a first controller configured to control braking of the wheel in response to a wheel speed signal outputted from one of the first and second wheel speed sensors;
a second controller configured to receive a wheel speed signal outputted from another of the first and second wheel speed sensors and communicationally connected with the first controller through a network of the vehicle;
a brake actuator associated with the wheel of the vehicle and configured to brake the wheel;
first and second brake drive circuits configured to control a power source of the brake actuator in response to control of the first controller;
an actuator housing to which the first and second wheel speed sensors are coupled and in which the first and second brake drive circuits are included; and
a plurality of circuits connecting the first wheel speed sensor, the second wheel speed sensor, the first brake drive circuit, and the second brake drive circuit to the first and second controllers.

11. The brake apparatus of claim 10, wherein:
the first controller comprises a first processor configured to receive the wheel speed signal of one of the first and second wheel speed sensors, and
the second controller comprises a second processor configured to receive the wheel speed signal of another of the first and second wheel speed sensors.

12. The brake apparatus of claim 11, wherein the plurality of circuits comprises first and second circuits separated from each other and configured to connect the first processor to the first brake drive circuit, the second brake drive circuit, or one of the first and second wheel speed sensors.

13. The brake apparatus of claim 12, wherein the first processor is configured to:
transmit a brake control signal, which is generated based on a wheel speed signal of one of the first and second wheel speed sensors, to at least one of the first and second brake drive circuits through one of the first and second circuits, and
supply power to at least one of the first and second brake drive circuits through another of the first and second circuits.

14. The brake apparatus of claim 12, wherein the first processor is configured to, in an abnormal state of one of the first and second brake drive circuits:
transmit a brake control signal to another of the first and second brake drive circuits through the first circuit, and
supply power to the another of the first and second brake drive circuits through the second circuit.

15. The brake apparatus of claim 11, wherein the plurality of circuits comprises third and fourth circuits separated from each other and configured to connect the second processor to the another of the first and second wheel speed sensors.

16. The brake apparatus of claim 15, wherein the second processor is configured to:
receive a wheel speed signal of the another of the first and second wheel speed sensors through one of the third and fourth circuits,
transmit the wheel speed signal of the another of the first and second wheel speed sensors to the first processor through the network of the vehicle, and
supply power to the another of the first and second wheel speed sensors through another of the third and fourth circuits.

17. The brake apparatus of claim 11, wherein the plurality of circuits is separated from one another and comprises:
first and second circuits configured to connect the first processor to the first brake drive circuit, the second brake drive circuit, and one of the first and second wheel speed sensors; and
third and fourth circuits configured to connect the second processor to the first brake drive circuit, and the second brake drive circuit, and another of the first and second wheel speed sensors.

18. The brake apparatus of claim 17, wherein:
the first processor is configured to transmit a brake control signal, which is generated based on a wheel speed signal of one of the first and second wheel speed sensors, to at least one of the first and second brake drive circuits through one of the first and second circuits, and
the second processor is configured to receive a wheel speed signal of another of the first and second wheel speed sensors through one of the third and fourth circuits, transmit the wheel speed signal of the another of the first and second wheel speed sensors to the first processor through the network of the vehicle, and supply power to at least one of the first and second brake drive circuits through one of the third and fourth circuits.

19. The brake apparatus of claim 18, wherein the first processor is configured to, in an abnormal state of one of the first and second brake drive circuits, transmit the brake control signal to another of the first and second brake drive circuits through one of the first and second circuits.

20. The brake apparatus of claim 18, wherein the second processor is configured to, in an abnormal state of one of the first and second brake drive circuits, supply power to another of the first and second brake drive circuits through one of the third and fourth circuits.
